(19) United States
(12) Patent Application Publication
(10) Pub. No.: US 2007/0286161 A1
(43) Pub. Date: Dec. 13, 2007

(54) Method and apparatus for establishing class of service across peering communication networks

(76) Inventors: Marian Croak, Fair Haven, NJ (US); Hossein Eslambolchi, Los Altos Hills, CA (US)

Correspondence Address: AT&T CORP., ROOM 2A207, ONE AT&T WAY, BEDMINSTER, NJ, 07921, US

(21) Appl. No.: 11/448,398

(22) Filed: Jun. 7, 2006

(51) Int. Cl. H04L 12/66; H04L 12/56

(52) U.S. Cl. 370/352; 370/401; 370/389

(57) ABSTRACT

A method and apparatus for enabling a peering arrangement between distinct packet networks so that traffic between these networks remains on the IP network from the point of origination to the point of termination are disclosed. IP peering is an arrangement that allows two or more IP carriers to be interconnected so that IP packets originating in one carrier can be terminated in another carrier's network. In one embodiment, the peering arrangement between packet networks is implemented while establishing a class of service across different packet networks.

The present invention relates generally to communication networks and, more particularly, to a method and apparatus for enabling peering between packet networks, e.g., Voice over Internet Protocol (VoIP) networks while establishing a class of service across different domains.

### BACKGROUND OF THE INVENTION

There are multiple VoIP network service providers offering an array of residential and teleworker services. When calls are placed between subscribers of these VoIP network services, they are still forced to traverse the PSTN networks even though they originate and terminate within the public IP network. For example, ISPs may use IP peering points to send traffic to IP destinations not directly on their network. This traffic is routed through appropriate network hops until it reaches its intended destination. In contrast, even though VoIP network providers ride on the IP network, they typically use the PSTN to route calls to endpoints connected to other VoIP network providers. Furthermore, these different domains may have different classes of service.

Therefore, a need exists for a method and apparatus for enabling peering between packet networks while establishing a class of service across different packet networks.

### SUMMARY OF THE INVENTION

In one embodiment, the present invention enables a peering arrangement between distinct packet networks so that traffic between these networks remains on the IP network from the point of origination to the point of termination. IP peering is an arrangement that allows two or more IP carriers to be interconnected so that IP packets originating in one carrier can be terminated in another carrier's network. In one embodiment, the peering arrangement between packet networks is implemented while establishing a class of service across different packet networks.

### BRIEF DESCRIPTION OF THE DRAWINGS

The teaching of the present invention can be readily understood by considering the following detailed description in conjunction with the accompanying drawings, in which:

FIG. 1 illustrates an exemplary IP network related to the present invention;

FIG. 2 illustrates an example of the peering between IP networks of the present invention;

FIG. 3 illustrates a flowchart of a method for enabling peering between IP networks by the originating carrier of the present invention;

FIG. 4 illustrates a flowchart of a method for enabling peering between IP networks by the terminating carrier of the present invention; and

FIG. 5 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

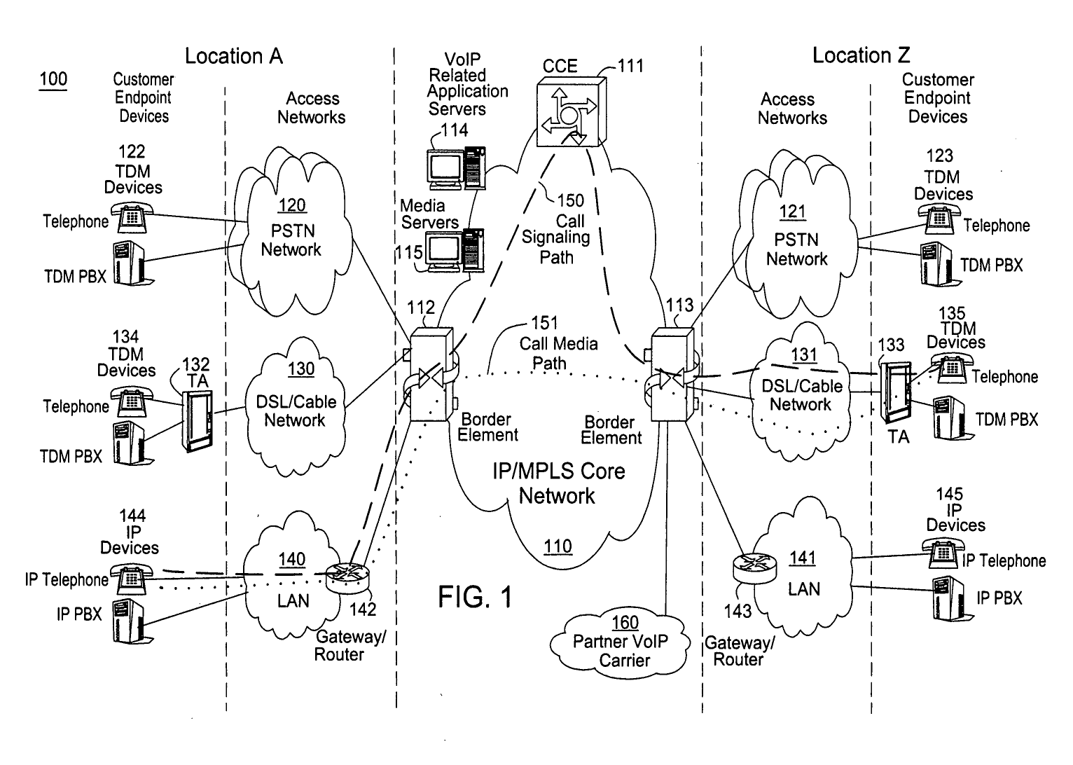

To better understand the present invention, FIG. 1 illustrates a communication architecture 100 having an example network, e.g., a packet network such as a VoIP network related to the present invention. Exemplary packet networks include internet protocol (IP) networks, asynchronous transfer mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted to be limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related servers in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related server 114 to obtain the information to complete this call. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP-ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call media path 151 are illustratively shown in FIG. 1. Note that the call signaling path and the call media path are different because once a call has been setup up between two endpoints, the CCE 111 does not need to be in the data path for actual direct data exchange.

Media Servers (MS) 115 are special servers that typically handle and terminate media streams, and to provide services such as announcements, bridges, transcoding, and Interactive Voice Response (IVR) messages for VoIP service applications.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

There are multiple VoIP network service providers offering an array of residential and teleworker services. When calls are placed between subscribers of these VoIP network services, they are still forced to traverse the PSTN networks even though they originate and terminate within the public IP network.

To address this criticality, the present invention enables a peering arrangement between distinct VoIP service networks so that traffic between these networks remains on the IP network from the point of origination to the point of termination. IP peering is an arrangement that allows two or more IP carriers to be interconnected so that IP packets can be originating in one carrier can be terminated in another carrier's network. In one embodiment, a specified class of service between these networks is supported by the present invention.

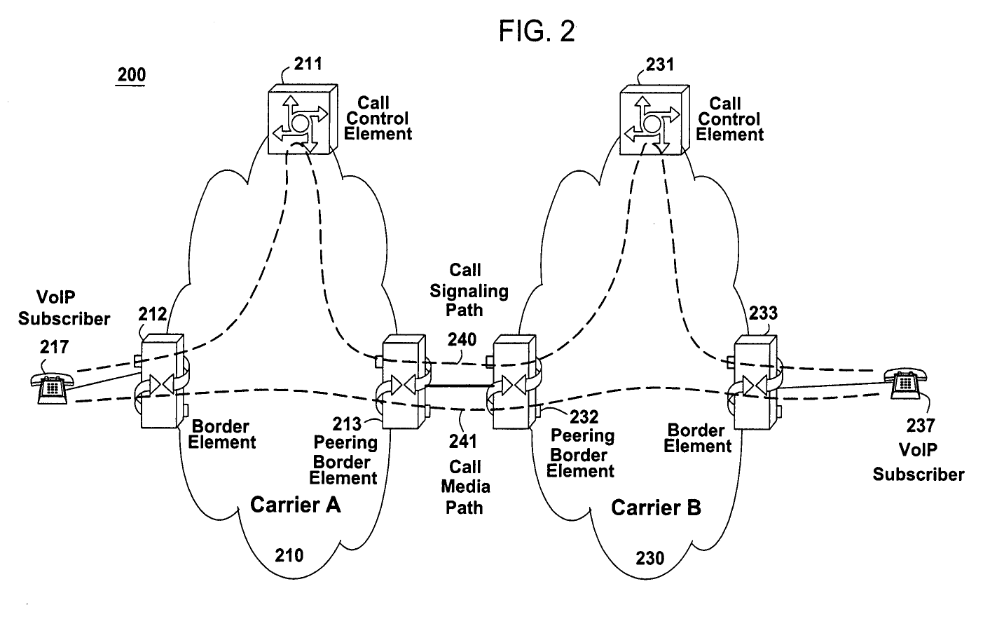

FIG. 2 illustrates an example of the peering between packet networks, e.g., VoIP networks. FIG. 2 comprises two exemplary VoIP carriers, 210 and 230, interconnected by Peering Border Element (PBE) 213 and PBE 232. In order to process calls between the two carriers, carrier A must contain a database of phone numbers that are terminated by carrier B and vice versa. Peering Border Element is a Border Element that interconnects two VoIP carrier networks.

In one embodiment, PBE 213 marks the edge of the network of carrier A and PBE 232 marks the edge of the network of carrier B. VoIP subscriber 217 in carrier A originates a call terminated at the VoIP subscriber 237 using signaling path 240. A call setup message is sent to CCE 211 for call processing. CCE 211 attempts to perform a translation from the called phone number to its corresponding IP address and finds out that the called number terminates in carrier B's network. In order to complete this call, CCE 211 sends the call setup message, along with the request to translate the called phone number into its corresponding IP address, to CCE 231 in carrier B's VoIP network traversing PBE 213 and 232. Note that PBEs 213 and 232 serve as the point of interconnection for both signaling and media packets between the two carriers.

When CCE 231 receives the call setup message, it translates the called number into its corresponding IP address. In one embodiment, the call setup message further contains a class of service or a quality of service parameter, e.g., a parameter that defines a Quality of Service (QoS) that is associated with the call request. CCE 231 then determines the BE pair to be used to complete the phone call in carrier B's network. In this case, PBE 232 and BE 233 comprise the BE pair to be used. Note also that PBE 213 to PBE 232 segment will also be used to interconnect the two carriers to complete the call. CCE 231 then sends a call acknowledgement message in response to the call setup message back to CCE 211 in carrier A's network traversing PBE 232 and 213.

Upon receiving the call acknowledgement message along with the translated IP address associated with the called phone number from CCE 231 from carrier B, CCE 211 of carrier A will determine the BE pair to be used to complete the call within carrier A's network. In this case, BE 212 and PBE 213 comprise the BE pair to be used. Note also that PBE 213 to PBE 232 segment will also be used to interconnect the two carriers to complete the call. Then CCE 211 sends a call acknowledgement message to the VoIP endpoint device used by subscriber 217 to complete the call setup procedures. Furthermore, the call is setup in accordance with the class of service or quality of service parameter. Namely, the call connection should meet or exceed the class of service or quality of service as specified in the call request.

Once the call has been setup, the call proceeds using media path 241. In this example, the media path comprises three BE to BE segments. The BE 212 to PBE 213 segment is within carrier's A network. The PBE 213 and PBE 232 segment is interconnecting carrier A and carrier B. The PBE 232 to BE 233 segment is within carrier's B network. Thus. using the present invention, the call is made without having to traverse one or more PSTN networks, while establishing a class of service across different packet networks.

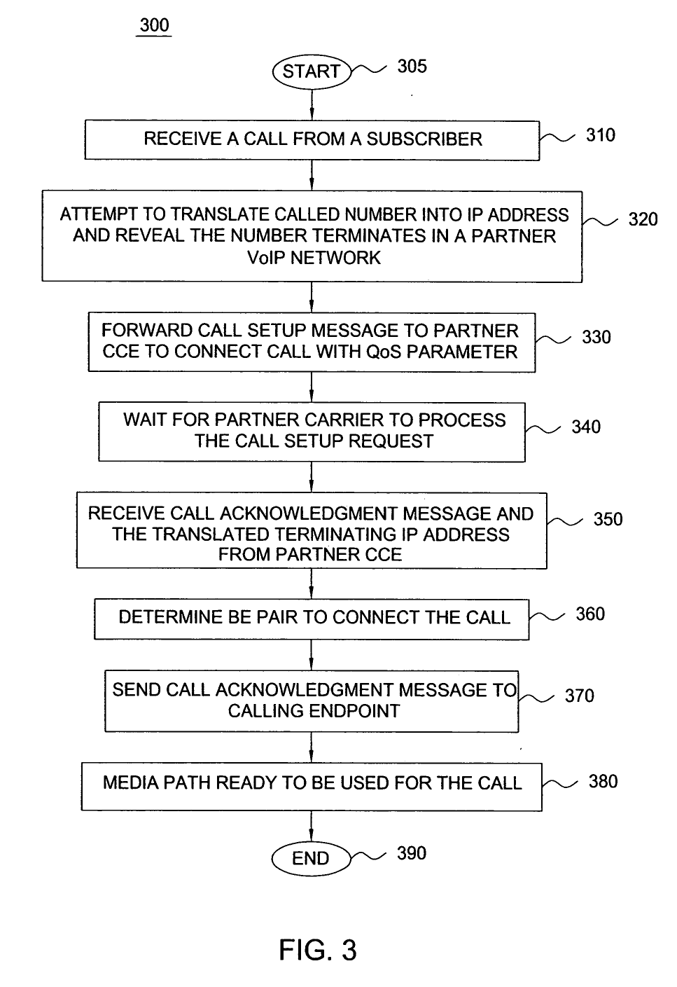

FIG. 3 illustrates a flowchart of a method 300 for enabling peering between VoIP networks by the originating carrier. For example, method 300 is executed by the CCE of the originating carrier. The method starts in step 305 and proceeds to step 310.

In step 310, the method receives a call setup message of a call from a subscriber. In one embodiment, the subscriber is a VoIP subscriber.

In step 320, the method attempts to translate the called phone number into its corresponding IP address and reveals that the called phone number terminates in a partner VoIP network.

In step 330, the method forwards the call setup message to the CCE in the partner's network. In addition, the method also requests the partner network CCE to translate the called phone number into its corresponding called party IP address. Furthermore, a class of service or quality of service associated with the subscriber is also forwarded to the partner network CCE. For example, the subscriber who originated the call request may have subscribed to a particular level of quality of service at a particular rate. The CCE of the originating carrier will want the partner network CCE to ensure that the subscribed level of quality of service is met or exceeded for the subscriber.

In step 340, the method waits for the partner network to process the call.

In step 350, the method receives a call acknowledgement message along with the translated called party IP address from the partners network's CCE.

In step 360, the method determines the BE-PBE path to be used to complete the call. Note that the inter-carrier PBE to PBE path is also determined at this point.

In step 370, the method sends a call acknowledgement message to the calling VoIP subscriber to complete the call.

In step 380, the media path can be used to carry a media stream across the networks to the called number subscriber using the established media path. It should be noted that established media path is sufficient to meet or exceed the quality of service specified in the call request. Method 300 ends in step 390.

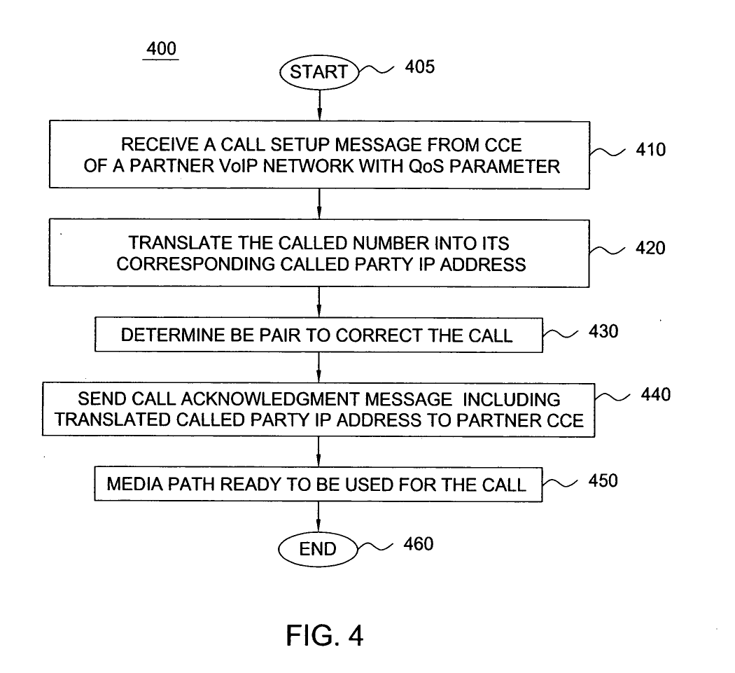

FIG. 4 illustrates a flowchart of a method 400 for enabling peering between VoIP networks by the terminating carrier. For example, method 400 is executed by the CCE of the terminating carrier. The method starts in step 405 and proceeds to step 410.

In step 410, the method receives a call setup message to a phone number terminated in its own network. The call setup message includes a quality of service parameter that specifies a particular level of quality of service that should be met or exceeded for the call to be established.

In step 415, the method translates the called party phone number into its corresponding called party IP address.

In step 420, the method determines the BE-PBE path in its own network to be used to complete the call. Note that the inter-carrier PBE to PBE path is also determined at this point.

In step 430, the method sends a call acknowledgement message along with the translated called party IP address back to the originating partner's CCE.

In step 440, the media path can be used to carry a media stream across the networks to the called number subscriber using the established media path. It should be noted that established media path is sufficient to meet or exceed the quality of service specified in the call request. Method 400 ends in step 450.

In order to ensure strict security between the two VoIP networks, private IP addressing is used between the two PBEs to restrict access to and from a partner's network. Therefore, the PBE of a carrier is only known to its partner's network PBE by its private IP address and this precludes unauthorized access through the PBEs from the public internet.

In addition, in order to facilitate billings and call settlements across the two VoIP networks, call transaction records must be exchanged between the two carriers for billing and settlement purposes. The type and format of transaction records to be exchange must be agreed upon by both carriers. For example, the specified quality of service for the call may impact how billing and settlement are implemented between the two networks. For example, the specified quality of service in the call request may be treated as a different quality level (e.g., a higher or a lower) at the partner network than at the originating network. As such, a different rate may be charged for meeting the specified quality of service specified in the call request.

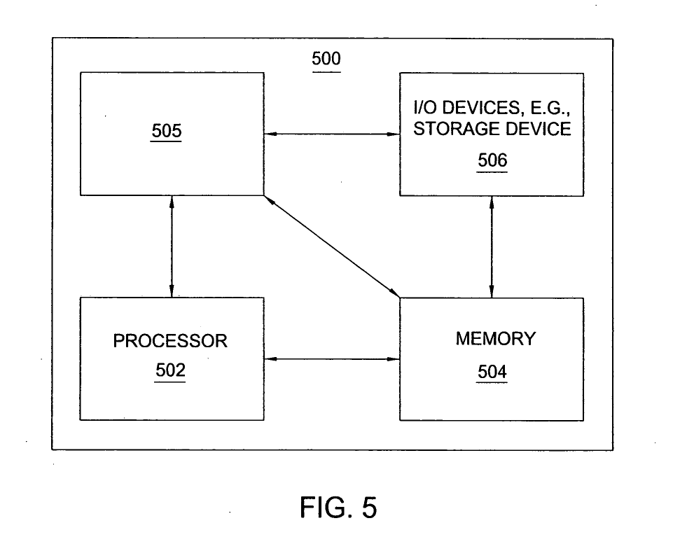

FIG. 5 depicts a high level block diagram of a general purpose computer suitable for use in performing the functions described herein. As depicted in FIG. 5, the system 500 comprises a processor element 502 (e.g., a CPU), a memory 504, e.g., random access memory (RAM) and/or read only memory (ROM), a peering module 505, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present peering module or process 505 can be loaded into memory 504 and executed by processor 502 to implement the functions as discussed above. As such, the present peering process 505 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for enabling peering between a plurality of packet networks, comprising:
receiving a call setup message in an originating carrier network destined to a terminating carrier network, where said call setup message is associated with a quality of service;
determining whether said terminating carrier network is a peer carrier network; and
processing said call setup message between said originating carrier network to said terminating carrier network via peer to peer communication in accordance with said quality of service.

2. The method of claim 1, wherein each of said originating carrier network and said terminating carrier network is a Voice over Internet Protocol (VoIP) network or a Service over Internet Protocol (SoIP) network.

3. The method of claim 1, wherein said call setup message is received by a call control element (CCE) of said originating carrier network.

4. The method of claim 1, wherein said processing comprises:
forwarding said call setup message from said originating carrier network to said terminating carrier network along with a quality of service parameter that specifies said quality of service.

5. The method of claim 4,
wherein said determining comprises translating a called party number in said call setup message to reveal said called party number is terminated in said terminating carrier network; and
wherein said forwarding comprises sending said call setup message along with said quality of service parameter from a call control element (CCE) of said originating carrier network to a CCE in said terminating carrier network.

6. The method of claim 4, further comprising:
receiving a call acknowledgement signaling message from said terminating carrier network.

7. The method of claim 6, whereon said call acknowledgement signaling message contains an IP address for a called party associated with said call setup message.

8. The method of claim 4, wherein said forwarding via peer to peer communication comprises:
determining a peer border element (PBE) to peer border element (PBE) path between said originating carrier network and said terminating carrier network.

9. The method of claim 4, wherein said call setup message is a Session Initiation Protocol (SIP) signaling message.

10. The method of claim 1, wherein said determining accesses a database of phone numbers terminated by at least one peer carrier network.

11. The method of claim 1, wherein said peer to peer communication between said originating carrier network and said terminating carrier network comprises at least one Peering Border Element (PBE) in said originating carrier network and at least one Peering Border Element in said terminating carrier network.

12. The method of claim 11, wherein said PBE in said originating carrier network and said PBE in said terminating carrier network employ private IP addressing.

13. The method of claim 1, further comprising:
exchanging call transaction related records between said originating carrier network and said terminating carrier network for billing.

14. A computer-readable medium having stored thereon a plurality of instructions, the plurality of instructions including instructions which, when executed by a processor, cause the processor to perform the steps of a method for enabling peering between a plurality of packet networks, comprising:
receiving a call setup message in an originating carrier network destined to a terminating carrier network, where said call setup message is associated with a quality of service;
determining whether said terminating carrier network is a peer carrier network; and
processing said call setup message between said originating carrier network to said terminating carrier network via peer to peer communication in accordance with said quality of service.

15. The computer-readable medium of claim 14, wherein each of said originating carrier network and said terminating carrier network is a Voice over Internet Protocol (VoIP) network or a Service over Internet Protocol (SoIP) network.

16. The computer-readable medium of claim 14, wherein said processing comprises:
forwarding said call setup message from said originating carrier network to said terminating carrier network along with a quality of service parameter that specifies said quality of service.

17. The computer-readable medium of claim 16,
wherein said determining comprises translating a called party number in said call setup message to reveal said called party number is terminated in said terminating carrier network; and
wherein said forwarding comprises sending said call setup message along with said quality of service parameter from a call control element (CCE) of said originating carrier network to a CCE in said terminating carrier network.

18. The computer-readable medium of claim 16, further comprising:
receiving a call acknowledgement signaling message from said terminating carrier network.

19. The computer-readable medium of claim 16, wherein said forwarding via peer to peer communication comprises:
determining a peer border element (PBE) to peer border element (PBE) path between said originating carrier network and said terminating carrier network.

20. A system for enabling peering between a plurality of packet networks, comprising:
means for receiving a call setup message in an originating carrier network destined to a terminating carrier network, where said call setup message is associated with a quality of service;
means for determining whether said terminating carrier network is a peer carrier network; and
means for processing said call setup message between said originating carrier network to said terminating carrier network via peer to peer communication in accordance with said quality of service.
